(19) United States
(12) Patent Application Publication
(10) Pub. No.: US 2014/0010917 A1
(43) Pub. Date: Jan. 9, 2014

(54) GLUCOSYLATED STEVIOL GLYCOSIDES COMPOSITION AS A TASTE AND FLAVOR ENHANCER

(71) Applicant: Siddhartha Purkayastha, Lombard, IL (US)

(72) Inventor: Siddhartha Purkayastha, Lombard, IL (US)

(73) Assignee: PURECIRCLE USA INC., Oak Brook, IL (US)

(21) Appl. No.: 14/005,850

(22) PCT Filed: Apr. 26, 2011
(86) PCT No.: PCT/US11/33912

§ 371 Date: Sep. 18, 2013

(30) Foreign Application Priority Data
Mar. 22, 2011 (US) 61466150

(51) Int. Cl. A23L 1/236

(52) U.S. Cl. CPC A23L 1/2363
USPC 426/48; 426/658; 426/590; 426/599; 426/580; 426/549; 426/618

(57) ABSTRACT

A taste and flavor profile enhancing composition is described. The composition includes glucosylated steviol glycosides which can enhance the intensity of a taste and/or a flavor in a food or beverage product.

### DESCRIPTION OF THE RELATED ART

Stevia rebaudiana Bertoni is a perennial shrub of the Asteraceae (Compositae) family native to certain regions of South America. The leaves of the plant contain from 10 to 20% of diterpene glycosides, which are around 150 to 450 times sweeter than sugar. The leaves have been traditionally used for hundreds of years in Paraguay and Brazil to sweeten local teas and medicines.

At present there are more than 230 Stevia species, some having significant sweetening properties. The plant has been successfully grown under a wide range of conditions from its native subtropics to the cold northern latitudes.

The extract of Stevia rebaudiana plant contains a mixture of different sweet diterpene glycosides, which have a single base—steviol and differ by the presence of carbohydrate residues at positions C13 and C19. These glycosides accumulate in Stevia leaves and compose approximately 10% -20% of the total dry weight. Typically, on a dry weight basis, the four major glycosides found in the leaves of Stevia are Dulcoside A, Rebaudioside C, Rebaudioside A and Stevioside. Other glycosides identified in Stevia extract include Rebaudioside B, D, E, and F, Steviolbioside and Rubusoside.

Steviol glycosides differ from each other (Table 1) by sweetness power as well as other sensory features attributing to taste quality such as bitterness, lingering aftertaste etc. The taste quality of a steviol glycoside is one of the major characteristics which is decisive for its usage in various food and beverage applications.

Previous studies show a certain correlation between number of glycosidic residues and the taste quality of a steviol glycoside. When comparing steviol glycosides rebaudioside A (having 4 glucose residues) clearly surpasses stevioside and rebaudioside B (each having 3 glucose residues) in taste quality. Steviolbioside and rubusoside (each having 2 glucose residues) have a taste quality that is proven to be significantly inferior than stevioside. In addition, the taste quality of rhamnosylated glycosides is inferior compared to glucosylated glycosides. (Tanaka, 1997).

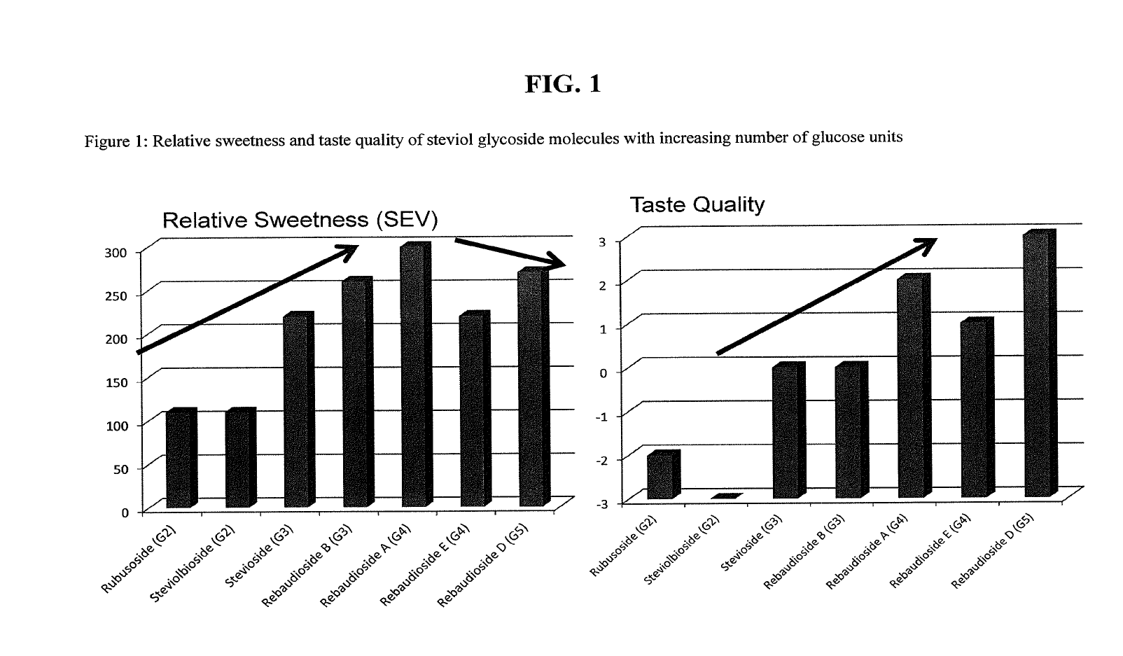

The sweetness and taste quality of steviol glycoside molecules containing only glucose units are plotted in FIG. 1. Steviol glycosides with a higher number of glucose residues, for example, more than two glucose residues, show a better taste quality. Particularly mono- and di-glucosyl forms of stevioside (having 4 and 5 glucose residues respectively) possess significantly better taste quality (Tanaka, 1997). However the relative sweetness does not increase beyond certain level as shown in FIG. 1.

TABLE 1
Steviol Glycoside molecules and their sweetness and taste quality

| | | | Sweetening power | |
|---|---|---|---|---|
| Steviol glycosides | R1 (C-19) | R2 (C-13) | relative to sucrose | Taste Quality |
| Stevioside (G3) | β-Glc | β-Glc-β-Glc(2-1) | 150-300 | 0 |
| Rebaudioside A (G4) | β-Glc | β-Glc-β-Glc(2-1)- | 200-400 | +2 |
| | | β-Glc(3-1) | | |
| Rebaudioside B (G3) | H | β-Glc-β-Glc(2-1)- | 300-350^{a} | 0 |
| | | β-Glc(3-1) | | |
| Rebaudioside C (G4) | β-Glc | β-Glc-α-Rha(2-1)- | 50-120 | −1 |
| | | β-Glc(3-1) | | |
| Rebaudioside D (G5) | β-Glc-β-Glc(2-1) | β-Glc-β-Glc(2-1)- | 200-300 | +3 |
| | | β-Glc(3-1) | | |
| Rebaudioside E (G4) | β-Glc-β-Glc(2-1) | β-Glc-β-Glc(2-1) | 250-300 | +1 |
| Rebaudioside F (G4) | β-Glc | β-Glc-β-Xyl(2-1)- | Na | Na |
| | | β-Glc(3-1) | | |
| Rubusoside (G2) | β-Glc | β-Glc | 110 | −2 |
| Steviolmonoside (G1) | H | β-Glc | Na | Na |
| Steviolbioside (G2) | H | β-Glc-β-Glc(2-1) | 100-125 | −3 |
| Dulcoside A (G3) | β-Glc | β-Glc-α-Rha(2-1) | 50-120 | −2 |

It is known that the undesired taste attributes can be substantially reduced or eliminated by the reaction of intermolecular transglycosylation of various enzymes, upon which the attachment of new carbohydrates at positions C13 and C 19 of steviol glycosides takes place. Tanaka (1997) evaluated the effect of adding glucose molecules to purified stevioside molecules by tranglycosylation. The resulting glucosylated steviosides were evaluated for their sweetness and taste quality. The improvement of taste quality was more when the glucose units were added to the C19 position rather at C13 position.

Various enzymes were used to conduct such transglycosylation. Pullulanase, isomaltase (Lobov et al., 1991), β-galactosidase (Kitahate et al., 1989), and dextrine saccharase (Yamamoto et al., 1994) as enzymes with pullulan, maltose, lactose, and partially hydrolyzed starch being donors.

The transglucosylation of steviol glycosides was also done by action of cyclodextrin glucanotransferases (CGTase). The obtained sweeteners possessed improved sweetness without bitterness and licorice taste (U.S. Pat. No. 4,219,571; 7,838,044, 7,807,206).

The glucosylated steviol glycosides mixture provides a certain amount of sweetness, but this invention shows that the glucosylated steviol glycosides (hereinafter, “GSG”) enhances flavor and the sweetness profile in a wide range of applications listed in, but not limited by, the categories shown in Table 2.

TABLE 2
GSG Applications

| Application | Product | Results |
|---|---|---|
| Beverages | Apple Blueberry Juice Drink | Significantly more berry flavor intensity than |
| | | the Control. Directionally, more acceptable |
| | | for overall flavor. |
| | Orange Pineapple Passion Fruit | Significantly more orange flavor intensity, |
| | Carbonated Drink | pineapple flavor intensity, and sweetness |
| | | intensity. |
| Baked | Lemon Poppy Seed Muffins | Significantly more overall flavor intensity and |
| Goods | | sweetness intensity than the Control. |
| | | Directionally, the Test sample was more |
| | | acceptable overall and had more lemon |
| | | flavor intensity |
| Processed | Strawberry Topping | Significantly less bitter than the control. |
| Fruits | | |
| Dairy | Banana Flavored Milk Drink | Significantly more overall flavor intensity, |
| | | banana flavor intensity, sweetness intensity, |
| | | tartness intensity and bitterness intensity. |

Similar taste and flavor improvements were found in other categories of products, including, but not limited to, table top sweeteners, sauces and gravies, confectionary products, baked goods, cereals, snacks, and fruit and vegetable preparations.

It is to be understood that the foregoing descriptions and specific embodiments shown herein are merely illustrative of the best mode of the invention and the principles thereof, and that modifications and additions may be easily made by those skilled in the art without departing for the spirit and scope of the invention, which is therefore understood to be limited only by the scope of the appended claims.

What is claimed is:

1. A taste and flavor enhancing composition, comprising glucosylated steviol glycosides.

2. The taste and flavor enhancing composition of claim 1, wherein the glucosylated steviol glycosides comprise more than two glucose units.

3. The taste and flavor enhancing composition of claim 1, wherein the glucosylated steviol glycosides comprise more than three glucose units.

4. The taste and flavor enhancing composition of claim 2, wherein at least one glucose unit occurs at position C-19 of the steviol glycoside.

5. A food or beverage product having an intense taste and flavor profile comprising the taste and flavor enhancing composition of claim 1.

6. The food or beverage product of claim 5, selected from the group consisting of a carbonated soft drink, a fruit juice, a dairy food, a dairy beverage, a baked good, a cereal products, and a table top sweetener.

7. A method for making the taste and flavor enhancing composition of claim 1, comprising the steps of:
a. Extracting steviol glycosides from leaves of a Steviol rebaudiana Bertoni plant; and
b. Transglycosylating the steviol glycosides to add glucose units to the steviol glycosides.

8. The method of claim 7, wherein transglycosylating the steviol glycosides comprises enzymatic transglycosylation using an enzyme selected from the group consisting of pullulanase, isomaltase, β-galactosidase, dextrine saccharase, and cyclodextrin glucotransferase.

9. A method of increasing a taste and flavor intensity of a food or beverage product, comprising the step of adding the taste and flavor enhancing composition of claim 1.

10. The food or beverage product of claim 5, wherein the intense taste and flavor profile is more intense than a comparative taste and flavor profile of a comparative food or beverage product.
